(19) United States
(12) Patent Application Publication
(10) Pub. No.: US 2001/0038490 A1
(43) Pub. Date: Nov. 8, 2001

(54) OPTICAL SYSTEM HAVING UNLIMITED DEPTH OF FOCUS

(76) Inventors: GEORGE S. TIGLIEV, ST. PETERSBURG (RU); FRANK S. LETCHER, TULSA, OK (US)

Correspondence Address: DR FRANK S LETCHER, 1145 S UTICA, SUITE 903, TULSA, OK, 74104

(21) Appl. No.: 09/429,193

(22) Filed: Oct. 28, 1999

(51) Int. Cl. G02B 21/06

(52) U.S. Cl. 359/388

(57) ABSTRACT

An optical system for use in a microscope and other optical systems has an unlimited depth of focus. The optical system comprises at least one lens, rotating mechanisms for continuously oscillating the focal length of the lens, and opaque elements for momentarily preventing light to pass through the lens. The rapid (i.e., greater than about 16 images a second) and sequential replacement of images in a plane parallel to and a fixed distance will provide an unlimited depth of focus to elicit in the observer a sense of sharp focus of the entire observed object.

### BACKGROUND OF THE INVENTION

1. Field of the Invention

The present invention relates to optical systems and, more particularly, to optical systems that have an unlimited depth of focus.

2. Description of Related Art

A well-known problem encountered with all optical systems is that for any system there is a relatively finite depth of focus, i.e., a fixed range of focus wherein portions of an object or one or more objects are in focus at the same time. A greater depth of focus is desired for presenting to the observer a more complete image of that which is observed. As is well known to those skilled in the art, the depth of focus of a lens system can be increased by increasing the focal length of the lens system and/or using smaller diameter apertures.

In the focus of microscopes, such as used for surgery or biological research, problems arise with using these prior approaches of increasing the depth of focus. In microscopes, there is a practical limit as to the useful length of the lens systems so the focal length is limited. As the magnification increases for a microscope, the depth of focus necessarily decreases, so that with most microscopes the observer is presented with an extremely thin visual image of the observed object that is in focus. When the diameter of the aperture is reduced, this necessarily limits the amount of light that is presented to the observer. To increase the brightness of the visual image, higher intensity lights must be directed at the observed object, either in reflected light systems or for transmitted light systems, which can cause actual harm to the observed object, such as living tissue.

Other methods of increasing the depth of focus of an optical system involve relatively complicated mechanisms to move or rapidly adjust the focus of the optical system, so that the observer is presented with a series of in focus images taken along a plurality of parallel planes passing through the observed object. The trouble with this arrangement is that the depth of focus remains the same, and only the focus is varied manually or by some mechanized means. Some of these prior optical systems are described in U.S. Pat. Nos. 4,448,498; 4,863,252; 5,054,896; 5,321,447; and 5,351,152.

### SUMMARY OF THE INVENTION

The present invention has been contemplated to overcome the foregoing deficiencies and meet the above described needs. Specifically, the present invention comprises at least one lens, rotating mechanism for continuously oscillating the focal length of the lens in stepwise increments, and opaque elements for momentarily preventing light to pass through the lens. The present invention permits a rapid and sequential presentation to the observer of in-focus images in a plane parallel to and at a fixed distance from the lens system to provide an unlimited depth of focus that elicits in the observer a sense of sharp focus of the entire observed object.

### BRIEF DESCRIPTION OF THE DRAWINGS

FIG. 1 is a semi-diagrammatic elevational view of a preferred embodiment of a lens system of the present invention, with a rotating carriage of lens elements.

FIG. 2 is a plan view of the lens system of FIG. 1.

FIG. 3 is a semi-diagrammatic elevational view of an alternate preferred embodiment of a lens system of the present invention, with dual rotating carriages of lens elements.

FIG. 4 is a plan view of the lens system of FIG. 3.

FIG. 5 is a cutaway side view of the edge between two adjoining lens elements.

### DETAILED DESCRIPTION OF THE PREFERRED EMBODIMENTS

The present invention is a lens system with an unlimited depth of focus, and is an improvement upon the lens system disclosed in U.S. Pat. No. 5,896,223, which has common inventorship herewith and which is herein incorporated by reference. The lens system of the present invention can be used within almost all forms of optical systems, such as still cameras, movie cameras, television cameras, binoculars, telephoto lenses, cathode ray tubes, image projection systems, and microscopes. For the purposes of the present discussion, the present invention will be referred to as being part of a microscope, and more particularly part of a mono- or bi-ocular microscope as used in surgery.

One of the major principles of the operation of the present invention is the well-known neuro-optical phenomena called “flicker fusion”, whereby the eye is presented with a sequential presentation of images to create the illusion of motion. Specifically, the effect of motion is achieved by the rapid sequential changing of frames of a movie film in a plane that is oriented parallel to and at a fixed distance from the object. This effect takes place when the frequency of image change is about 16-24 frames per second or greater. The inventors hereof have adapted this “flicker fusion” principle into a lens system to provide an unlimited depth of focus for a lens system.

For the purposes of the present discussion, the term “unlimited depth of focus” means that the depth of focus of a preferred embodiment of the lens system of the present invention is greater than the depth of focus of a substantially identical prior lens system with a fixed depth of focus. Care should be taken to note that “unlimited” does not mean infinite or without end, but it means that it is not normally constrained. As will be described in more detail below, one preferred method for achieving an unlimited depth of focus is by having at least one lens and a rotating mechanism for continuously oscillating the focal length of the lens in stepwise increments. This repetitive change in focal length by a specific increments (e.g., distance) and sufficient frequency (e.g., changes of images per second) will elicit in the observer a sense of sharp focus of the observed object. In other words, instead of providing the observer with a single very thin plane of focus (as in prior lens systems), the present invention provides the observer with an in-focus relatively thick stack of planes of focus.

To ensure clarification of what is meant by the terms “continuously oscillating” and “stepwise increments”, the following should be understood. The above wording is not restricted to any actual vertical movement of a lens. All that is required is that the focal length of the lens be oscillated, i.e., from one value Y-min. to another value Y-max., and then back, and in stepwise increments, i.e., value Y1, Y2, . . . These increments can have a stop-start motion or be smooth and continuous. So, the “oscillating” can occur by the rotational movement of the lens and/or one or more lens elements.

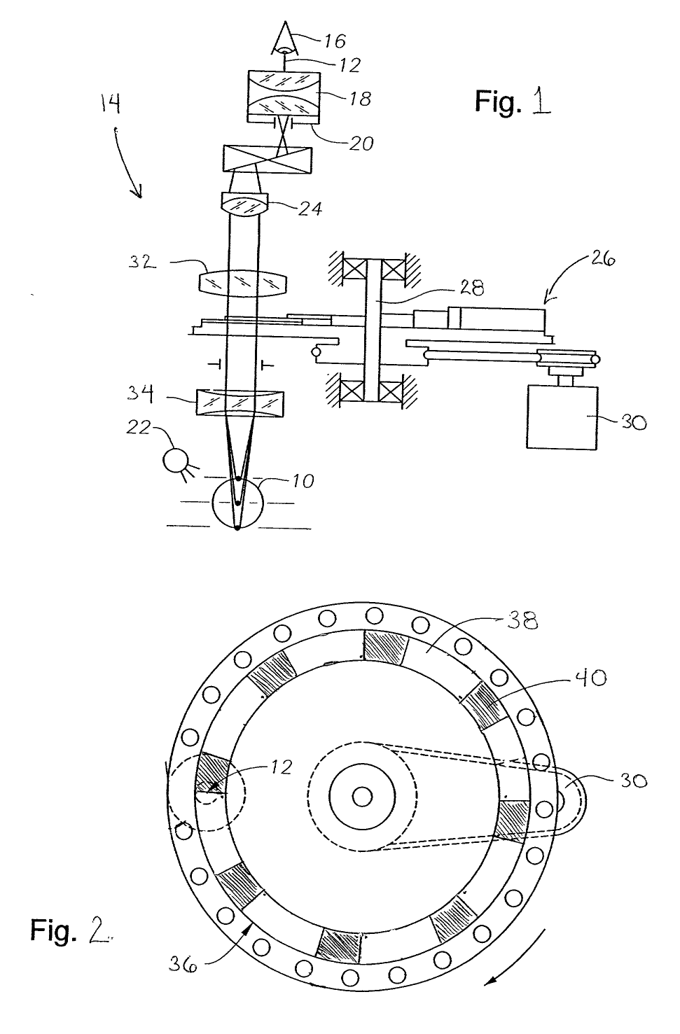

Turning now to the drawings, FIGS. 1 and 2 show one preferred embodiment of the present invention wherein an object 10 to be observed, such as all or a portion of an anatomical specimen, is located generally within the longitudinal optical axis 12 of a lens system 14 of the present invention. An eye 16 of an observer is shown viewing a magnified optical image of the object 10, in line with the longitudinal optical axis 12, through a magnifying eye piece or ocular 18, having one or more lens elements. The lens system 14 has an adjustable diaphragm 20, within the ocular 18 or adjacent thereto, to adjust the amount of light that passes there through. This diaphragm 20 is particularly helpful when viewing a wet or highly reflective object 10 under high intensity light, such as provided by a light source 22. In addition, the smaller the diaphragm opening, the greater the depth of focus of the lens system, as is well known to those skilled in the art. An intermediate tubular lens 24, comprising one or more optical elements, may be included, and which is spaced from the ocular 18 and lies within the longitudinal optical axis 12.

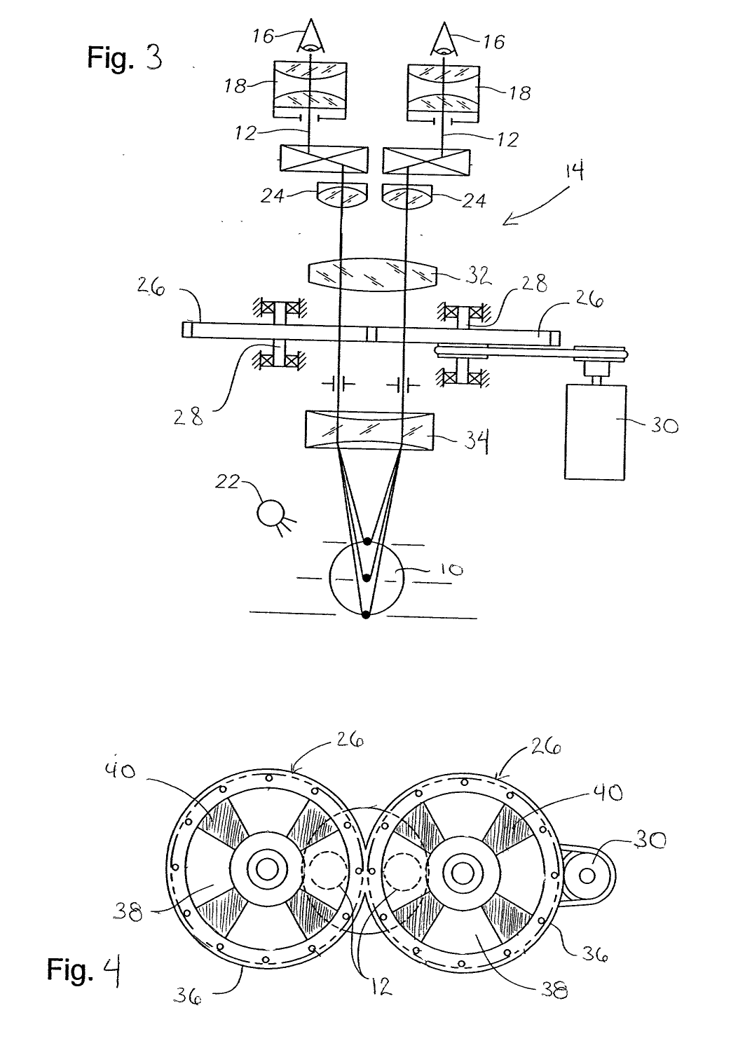

The embodiment shown in FIGS. 1 and 2 are for a single lens system, and an alternate preferred embodiment is shown in FIGS. 3 and 4 for a dual lens system, such as used in a surgical microscope. In one preferred embodiment a circular carriage 26 is rotated, preferably continuously and smoothly, about a vertical axle 28 by a gear and/or a belt and motor mechanism 30. The carriage 26 rotates about a vertical axis that is parallel to the optical axis 12. An outer radius portion of the carriage 26 rotates through the optical axis 12 between one or more lens fixed elements 32 and 34. This outer radius portion of the carriage 26 includes a ring 36 of a plurality of lens elements 38. Each lens element 38 has essentially the same (constant) optical characteristics across its dimensions, yet each lens element 38 has a different optical characteristic from the immediately adjacent lens element 38. The optical characteristics of the lens elements 38 vary by having differences in material, density, color, polarization, types of optical coatings, shape, thickness, and/or curvature.

The ring 36 has the lens elements 38 arranged in a pattern so that as each lens element 38 is rotated through the optical axis 12 a sequence of images is presented to the observer 16. For example, the ring 36 in FIG. 2 has 8 individual lens elements 38, and the pattern of optical characteristics can vary sequentially, such as elements #1, 2, 3, . . . , 7, 8, 1, 2, . . . However, the lens elements 38 can vary in a repeating pattern, such as elements #1, 2, 3, . . . , 7, 8, 7, . . . , 3, 2, 1; or, any other pattern may be used as desired.

It should be noted that since each lens element 38 has essentially the same (constant) optical characteristics across its dimensions, so that as each lens element 38 is rotated through the optical axis 12, the image presented to the observer 16 will remain essentially the same during that time period, even though the lens element 38 is continuously moving. To provide the observer with the desired unlimited depth of focus through the rapid and sequential replacement of differing visual images, a series of opaque elements 40 are interspersed between the lens elements 38. These opaque elements 40 can be any desired shape, size and configuration and made from any desired material as long as each element 40 prevents the passage of light there through. One preferred embodiment is for the opaque elements to be made from opaque styrene plastic to reduce weight in relation to using a metallic material. It is preferred to have the opaque elements 40 be of relatively short in length in comparison to the length of the lens elements 38. This is to allow the maximum amount of light to pass through to the eye 16 of the observer and to minimize the duration of any “blanking” caused by an opaque element 40 passing through the optical axis 12.

The inventors hereof have found that the opaque elements 40 act as a shutter to momentarily block the image passing to the eye 16 of the observer when there is a transition from one image to the next. In other words, when the trailing edge of a first lens element 38 comes to the optical axis 12, there should be a blockage of an image until the leading edge of the next lens element 38 passes past the optical axis 12. In certain circumstances where the absolute maximum amount of light is needed to pass to the observer, the use of the opaque elements 40 may not be desired. The inventors hereof have found that with a relatively rapid rotation of the carriage 26, such as from about 60 rpm to about 150 rpm, the opaque elements 40 can be eliminated and still provide a crisp image transition from one lens element 38 to the adjacent lens element.

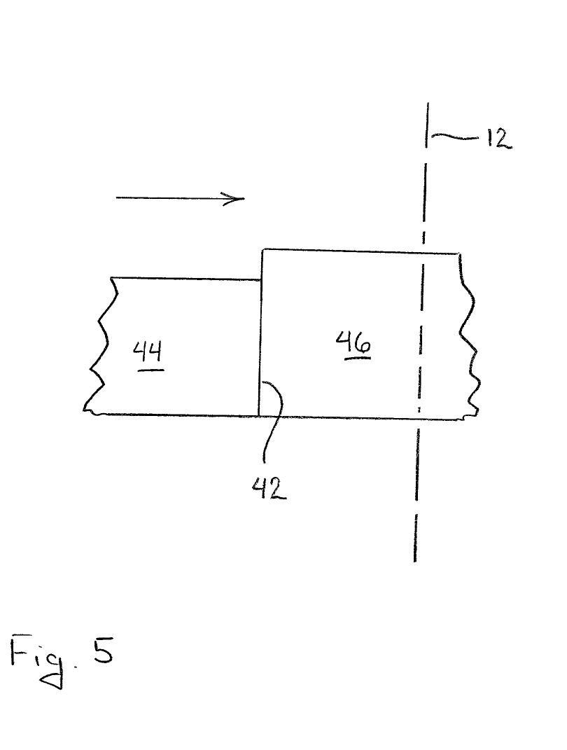

The inventors have found that the abutting edge between adjacent lens elements 38 are preferably matched and configured to provide an optically distinct transition. FIG. 5 shows an abutting edge 42 formed between a first lens element 44 and an adjacent second lens element 46, which has a different optical characteristic than the first lens element 44. This edge 42 is preferably formed by having the respective side edges of the lens elements 44 and 46 being formed and polished so as to be parallel to the optical axis 12, and straight as possible through their radial extent. One edge or both edges of the lens elements 44 and 46 are preferably polished to be optically transparent. The result is that as each abutting edge 42 passes through the optical axis 12 there is a crisp and clear optical break between the optical image presented by the lens element 44 and then the lens element 46.

The inventors hereof have found that the lens systems 14 shown in FIGS. 1-5 have at least two advantages over prior systems that vertically move the lens, especially when used in relatively high magnification systems. First, is the reduction in vibration caused by the elimination of the incremental vertical movement of the lenses. Second, is the ability to provide a brighter image to the viewer. The brighter image is a result of the absence of a shutter and the lens elements 38 being within the optical axis a majority of the time due to their relative greater length as compared to the length of the opaque elements 40. Further, in the alternate preferred embodiment, the brightest image is obtainable due to the absence of any opaque elements 40.

The inventors hereof have found that the principle of “unlimited depth of focus” can be used in any device or system where lenses are used. Yet, conventional lens structures need not be used. The principle can be adapted for use with lenses formed from one or more crystals, crystal laminates, plastic or ceramic laminates, gels, gasses, and liquids. In addition, actual physical movement of one or more of the lenses need not occur to change the focal length in the manner contemplated herein.

As has been described above, with the present invention light is permitted to pass through the lens system when the lenses, and therefore the focal length of the lens system, are momentarily fixed and light is prevented from passing through the lens set when the focal length is not momentarily fixed. The rapid and sequential replacement of differing visual images presented to an observer in a parallel plane and at a fixed distance provide an unlimited, i.e., far greater than previously obtainable with a comparable prior lens system, depth of focus to elicit in the observer a sense of sharp focus of the observed object.

Whereas the present invention has been described in relation to the drawings attached hereto, it should be understood that other and further modifications, apart from those shown or suggested herein, may be made within the scope and spirit of the present invention.

What is claimed is:

1. An optical system having unlimited depth of focus, comprising:
at least one lens;
rotating mechanism for continuously oscillating the focal length of the lens in stepwise increments; and
opaque elements for momentarily preventing light to pass through the lens.

2. An optical system having unlimited depth of focus, comprising:
at least one lens;
rotating mechanism for continuously oscillating the focal length of the lens; and
opaque elements carried on the rotating mechanism for preventing light to pass through the lens.

3. An optical system having unlimited depth of focus, comprising:
at least one lens;
rotating mechanism for continuously oscillating the focal length of the lens in stepwise increments; and
opaque elements carried on the rotating mechanism for preventing light to pass through the lens when the focal length is not momentarily fixed.

4. An optical system having unlimited depth of focus, comprising:
a plurality of lens sets, each comprising at least one optical element, and each having a different optical characteristic;
rotating mechanism for continuously and sequentially moving the lens sets into line with a longitudinal optical axis of the lens system; and
opaque elements for momentarily preventing light to pass to the viewer when one of the lens sets is not momentarily fixed in position.

5. An optical system of claim 4 wherein the plurality of lens sets are carried upon a carriage that rotates about a longitudinal axis parallel to the optical axis.

6. An optical system having unlimited depth of focus, comprising:
a plurality of lens sets, each comprising at least one optical element, and each having a different optical characteristic;
rotating mechanism for continuously and sequentially moving the lens sets into line with a longitudinal optical axis of the lens system; and
opaque elements carried on the rotating mechanism for momentarily preventing light to pass to the viewer when one of the lens sets is not momentarily fixed in position.

7. An optical system of claim 6 wherein the plurality of lens sets are carried upon a carriage that rotates about a longitudinal axis parallel to the optical axis.

8. An optical system having unlimited depth of focus, comprising:
a lens set comprising a plurality of optical elements each having a different optical characteristic;
rotating mechanism for continuously moving the optical elements into line with a longitudinal optical axis of the lens system; and
opaque elements for preventing light to pass to the viewer during an image transition.

9. An optical system of claim 8 wherein the plurality of optical elements are carried upon a carriage that rotates about a longitudinal axis parallel to the optical axis.

10. An optical system having unlimited depth of focus, comprising:
at least one lens; and
rotating mechanism for continuously oscillating the focal length of the lens.

11. An optical system of claim 10 wherein the rotating mechanism continuously oscillates the focal length of the lens in stepwise increments.

12. An optical system having unlimited depth of focus, comprising:
a first optical element and a second optical element, each having a different optical characteristic;
rotating mechanism for sequentially moving the first and the second optical elements into line with a longitudinal optical axis of the lens system; and
abutting edges of the first optical element and the second optical element being configured to form an optically distinct transition.

13. An optical system of claim 12 wherein the optical elements are carried upon a carriage that rotates about a longitudinal axis parallel to the optical axis.
